(19) United States
(12) Patent Application Publication
(10) Pub. No.: US 2014/0178713 A1
(43) Pub. Date: Jun. 26, 2014

(54) MAGNETIC READ SENSOR WITH DUAL LAYER INSULATION

(71) Applicant: HGST NETHERLANDS B.V., Amsterdam (NL)

(72) Inventors: Quang Le, San Jose, CA (US); Simon H. Liao, Fremont, CA (US); Guangli Liu, Pleasanton, CA (US)

(73) Assignee: HGST Netherlands B.V., Amsterdam (NL)

(21) Appl. No.: 13/725,670

(22) Filed: Dec. 21, 2012

(51) Int. Cl. G11B 5/127

(52) U.S. Cl. CPC G11B 5/127
USPC 428/810; 427/595; 427/127; 216/22

(57) ABSTRACT

A magnetic read sensor having reduced hard bias free layer spacing and improved insulation robustness between the hard bias layers and the shield and sensor. The read sensor has a novel bi-layer insulation layer that can be made very thin while also providing good electrical insulation to prevent sense current shunting. The bi-layer insulation layer can be made by a process that provides improved sensor performance.

### FIELD OF THE INVENTION

The present invention relates to magnetic data recording and more particularly to a magnetic read sensor having an insulation layer formed by a dual layer process that provided improved protection against electrical shunting and also provides sensor's protection from oxygen diffusion for improved sensor performances.

### BACKGROUND OF THE INVENTION

The heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider into contact with the surface of the disk when the disk is not rotating, but when the disk rotates air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes at least one coil, a write pole and one or more return poles. When a current flows through the coil, a resulting magnetic field causes a magnetic flux to flow through the write pole, which results in a magnetic write field emitting from the tip of the write pole. This magnetic field is sufficiently strong that it locally magnetizes a portion of the adjacent magnetic disk, thereby recording a bit of data. The write field, then, travels through a magnetically soft under-layer of the magnetic medium to return to the return pole of the write head.

A magnetoresistive sensor such as a Giant Magnetoresistive (GMR) sensor or a Tunnel Junction Magnetoresistive (TMR) sensor can be employed to read a magnetic signal from the magnetic media. The magnetoresistive sensor has an electrical resistance that changes in response to an external magnetic field. This change in electrical resistance can be detected by processing circuitry in order to read magnetic data from the adjacent magnetic media.

As sensors become ever smaller, the magnetic free layer becomes inherently magnetically unstable and requires improved magnetic biasing to remain stable. The sensor is separated from the bias layers by an insulation layer to prevent shunting of sense current through the hard bias layers. To provide a strong bias field for biasing the free layer and improved sensor performance, the insulation layers should be made as small as possible and incorporate oxygen barrier material. However, thinner insulation layers risk shunting due to pin holes or other defects in the insulation.

### SUMMARY OF THE INVENTION

The present invention provides a magnetic read sensor that includes a magnetic shield, a sensor stack having a side and formed on the magnetic shield, and a bi-layer insulation layer firmed over the side of the sensor stack and over the magnetic shield. The bi-layer insulation layer has a first insulation layer and a second insulation layer formed over the first insulation layer. The magnetic read sensor can be manufactured by forming a sensor structure having first and second sides over a magnetic shield, depositing a first insulation layer over the sensor structure by ion beam deposition or physical vapor deposition and depositing a second insulation layer by atomic layer deposition over the first insulation layer.

The first insulation layer can be deposited to exploit optimal targeted thickness coverage on side of sensor and very thin without the need to completely avoid pin holes or other defects and acts to passivate the sensor structure from oxygen diffusion prior to deposition of the second insulation layer. The second insulation conformally fills any pin holes or defects, effectively sealing the first insulation layer and ensuring excellent electrical insulation to avoid shunting. The first insulation deposition can use ion beam deposition to achieve optimal targeted non-conformal coverage while second insulation deposition can use atomic layer deposition for conformal coverage.

These and other features and advantages of the invention will be apparent upon reading of the following detailed description of preferred embodiments taken in conjunction with the figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon;

FIG. 3 is an air bearing surface view of a prior art magnetic read sensor;

FIG. 4 is an enlarged view of a bi-layer insulation layer of the sensor of FIG. 3; and

FIGS. 5-15 show a magnetic sensor in various intermediate stages of manufacture in order to illustrate a method of manufacturing a magnetic sensor according to an embodiment of the invention.

### DETAILED DESCRIPTION OF THE PREFERRED EMBODIMENTS

The following description is of the best embodiments presently contemplated for carrying out this invention. This description is made for the purpose of illustrating the general principles of this invention and is not meant to limit the inventive concepts claimed herein.

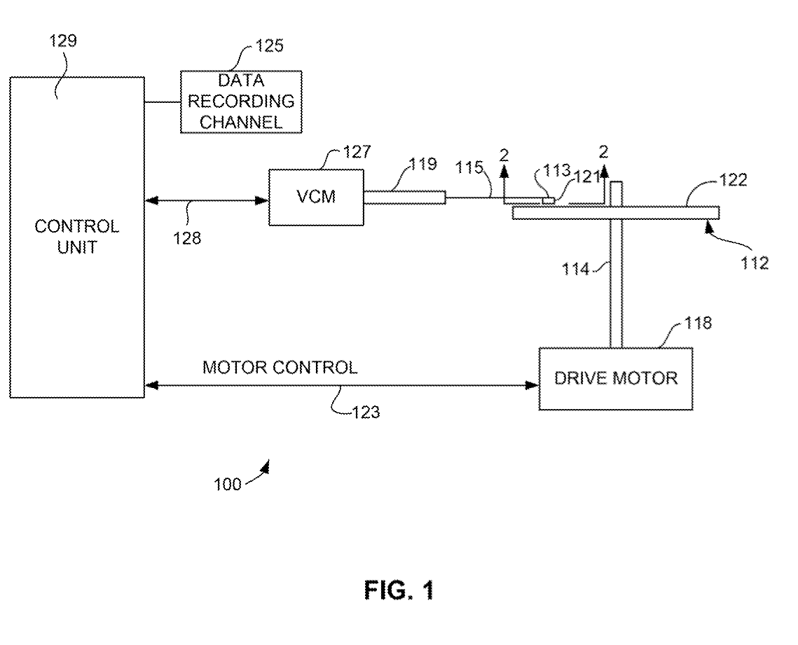

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 can access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

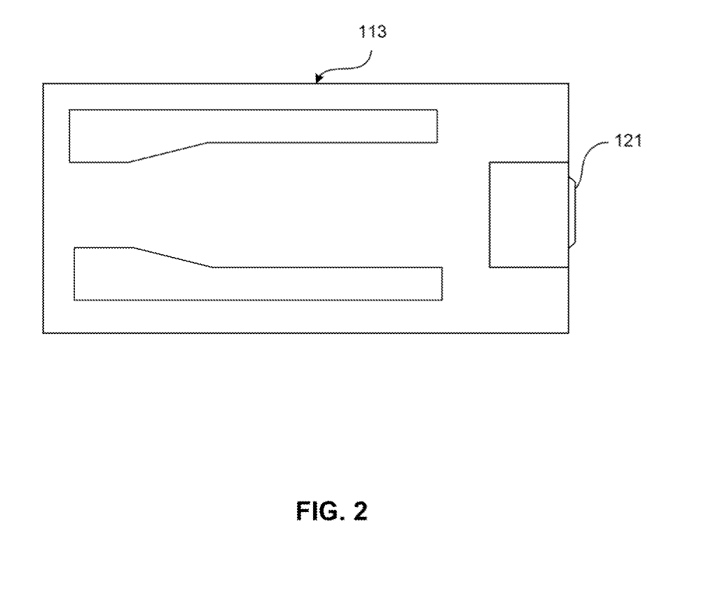

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system and the accompanying illustration of FIG. 1 are for representation purposes only. It should be apparent that disk storage systems may contain a large number of disks and actuators, and each actuator may support a number of sliders.

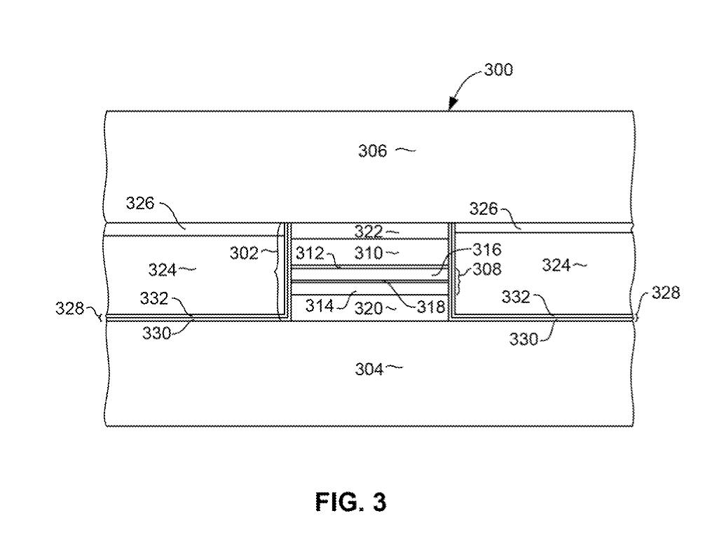

FIG. 3 shows a view of a magnetic read head 300 as viewed from the air bearing surface. The read head 300 is sandwiched between upper and lower magnetic shields 304, 306 that are constructed of an electrically conductive, magnetic material such as NiFe so that they can function as electrically conductive leads as well as magnetic shields.

The sensor stack can include a magnetic pinned layer structure 308, a magnetic free layer structure 310 and a non-magnetic barrier or spacer layer 312 sandwiched between the magnetic pinned layer structure 308 and the magnetic free layer structure 310. If the sensor 300 is a giant magnetoresistive sensor (GMR) then the layer 312 can be an electrically conductive, non-magnetic spacer layer such as Cu. If the sensor 300 is a tunneling magnetoresistance sensor (MR), then the layer 312 can be a thin, non-magnetic, non-electrically conductive barrier layer such as MgO. The sensor stack 302 can also include a capping 322 layer that protects the under-lying layers such as the free layer 310 during manufacture, and which magnetically de-couples the free layer 310 from the upper shield 306.

The pinned layer structure can be constructed as an antiparallel coupled structure that includes first and second magnetic layers 314, 316 that are anti-parallel coupled across an antiparallel coupling layer such as Ru 318. The first magnetic layer 314 can be exchange coupled with an antiferromagnetic layer 320 which can be a material such as PtMn or IrMn. This exchange coupling pins the magnetization of the first layer 314 in a first direction perpendicular to the air bearing surface. The anti-parallel coupling between the first and second magnetic layers 314, 316 pins the magnetization of the second layer 316 in a second direction that is anti-parallel to the first direction and which is also perpendicular to the air hearing surface.

The free layer structure 310 has a magnetization that is biased in a direction that is parallel with the air bearing surface, but which is free to move in response to a magnetic field, such as from a magnetic medium. Biasing of the magnetization of the free layer 310 is provided by hard magnetic bias structures 324, 324 at either side of the sensor stack 302. The hard bias layer are constructed of as high coercivity magnetic material such as CoPt or CoPtCr. Hard bias capping layers 326 can be provided at the top of the hard bias structures 324 to protect the hard bias layers 324 and also to magnetically de-couple the hard bias layers 324 from the upper magnetic shield 306.

The hard bias layers 324 are separated from the sensor stack 302 and from the bottom shield 304 by a novel, bi-layer insulation layer 328 that includes a first layer 330 and a second layer 332 formed over the first insulation layer. The novel bi-layer insulation layer 328 allows for reduced insulation thickness so as to reduce the spacing between the hard bias layers 324 and the sensor stack 302, thereby improving free layer biasing and improve sensor performance with the first insulation consisting of an oxygen diffusion barrier material. The novel bi-layer insulation layer 328 achieves this reduced spacing and improved sensor performance while also ensuring good electrical insulation between the hard bias layer 324 and the shield 304 and sensor stack 302, thereby preventing shunting.

Atomic layer deposition has been used to form insulation layers in magnetic sensors. However, as sensors become ever smaller, it has become ever more challenging to form an insulation layer that is sufficiently thin to achieve good free layer biasing and also avoid insulation defects such as pin holes that can allow for current shunting. In practice it has only been possible achieve insulation thickness down to about 30 nm without experiencing shunting. In addition, the exposure of the sensor to atomic layer deposition can cause damage to the layers of the sensor stack, resulting in degradation in pinned layer pinning and higher head resistance due to some part to oxygen diffusion into sensor.

In general a layer deposited by atomic layer deposition is deposited by pulsing and purging cycles of TMA (trimethylaluminum) and H₂O precursors at defined temperature. Adjustments of the pulse time affects the amount of surface saturation and is sensitive when it comes to wafers with a large surface topography, as each pulse must cover a larger surface area than it would on a flat surface. On the other hand, adjustment of the purge time affects uniformity, as there is a period of time for the precursor to be purged out of the chamber before the next pulse can begin. If purge time is insufficient, a chemical vapor deposition reaction mechanism can occur that leads to lower quality and less uniform film.

In order to improve throughput, the precursor pulses and purges are kept to the absolute minimum necessary to cover the surface of a silicon wafer to achieve target thickness and uniformity that is required. The challenge of the atomic layer deposition process when applied to magnetic sensors can be explained by its pulse and purge cycles. The inability to achieve thinner film can be due to insufficient pulse time as compared to atomic layer deposition applied to a silicon film. This can be due to the photoresist used in the processing of magnetic sensors that adsorbs the precursors, preventing saturation. In addition, damage to the sensor can be the result of insufficient purge time that can be attributed to the oxygen-containing by-product build-up resulting from atomic layer deposition processing.

Studies have been conducted in an attempt to find pulse and purge cycles that can produce thinner atomic layer deposition films with less damage to the senor, but no such acceptable process has been found.

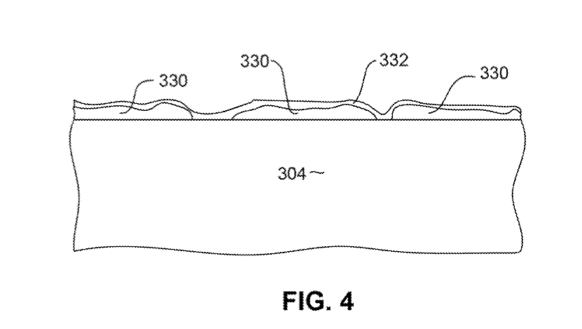

The present invention overcomes these challenges, providing a method to deposit a novel insulation structure 328 that can minimize damage to the sensor 302 while forming a very thin defect free insulation layer 328. With reference to FIG. 4, which shows an enlarged view of a portion of the insulation structure 328 including the first layer 330 and second layer 332 deposited thereover. The first layer 330 is deposited by ion beam deposition or physical vapor deposition. Then, the second layer 332 is deposited by atomic layer deposition. In this way, ion beam deposition (IBD) or physical vapor deposition (PVD) can be used to deposit the first layer without concerns regarding non-conformal coverage or pin holes so that the first layer can be deposited very thin and exploit non-conformal coverage with adjusting deposition angles in IBD or vertical deposition with PVD to 20 nm or less. The first layer 330, being deposited by ion beam deposition or physical vapor deposition passivates the sensor 302, device geometry and phostoresist (explained later) to grow conformal the second layer 332 by atomic layer deposition without the above discussed challenges such as damage to the sensor 302 or thickness control.

The second layer 332, deposited by atomic layer deposition acts as a liner, filling in any pin holes or defects in the first layer 330 and provides an excellent breakdown voltage for superior electrical insulation robustness. It effectively seals the first insulation layer 330.

The first layer 330 can be oxygen deficient alumina (Al₂O₃₋ₓ) or can be SiNx, SiOx, Ny, or MgO to act as an O₂ diffusion barrier for improved sensor stability. In addition, the ion beam deposition or physical vapor deposition tool provides optimal non-conformal spacing between the free layer 310 and hard bias 324, and good separation between the hard bias 324 and bottom shield 304. By using this bi-layer technique, the first insulation layer 330 can be deposited in a non-conformal manner using ion beam deposition or physical vapor deposition to produce a film that is thinner on the side of the sensor stack 302 than it is over the shield 304. The ion beam or physical vapor deposition provides optimal free layer 310 to hard bias 324 spacing and good hard bias 324 to shield spacing.

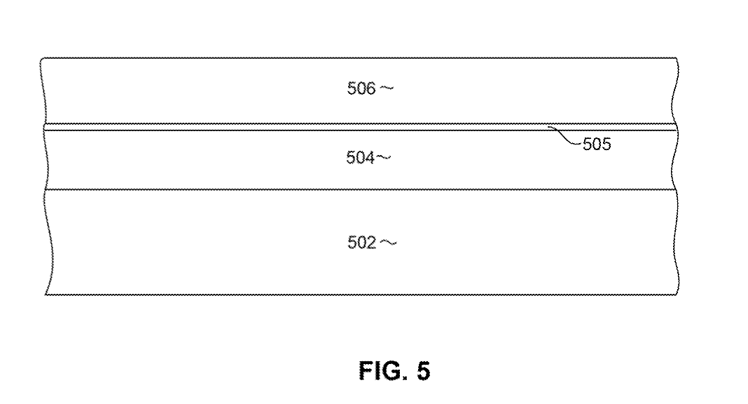

FIGS. 5-14 show a magnetic sensor in various intermediate stages of manufacture in order to illustrate a method of manufacturing a magnetic read sensor according to embodiment of the invention. With particular reference to FIG. 5, a bottoms shield 502 is formed, and a plurality of sensor layers, referred to collectively as sensor layer 504 is deposited over the shield 502. The sensor layer 504 can include the various layers of the sensor structure 302 described above with reference to FIG. 3 or could be layers of some other type of sensor. A layer or material that is resistant to chemical mechanical polishing (CMP stop layer) 505 can be deposited over the sensor layer 504. The CMP stop layer 505 can be a material such carbon or diamond like carbon. Then, a mask layer 506 is deposited over the sensor layer 504 and CMP stop layer 505. The mask layer 505 includes a photoresist mask, and may also include other layers such as a bottom anti-reflective coating, hard mask, image transfer layer, etc.

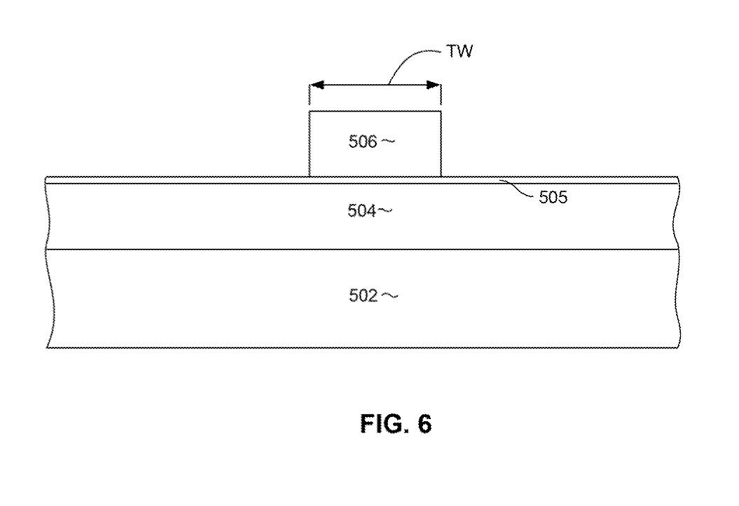

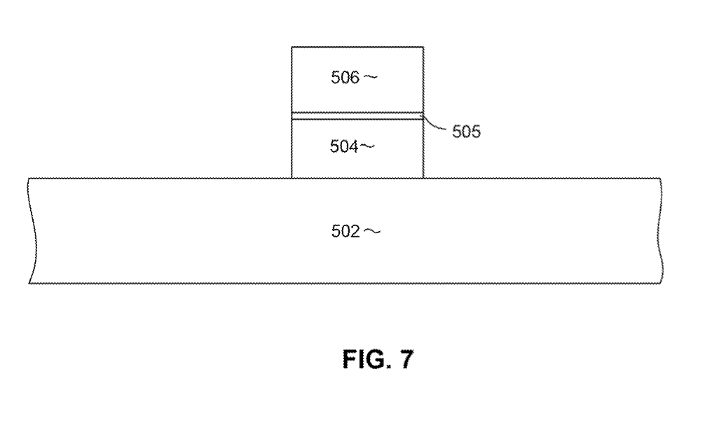

With reference to FIG. 6, the photoresist is patterned to define a sensor dimension. For purposes of illustration the mask 506 will be considered to be configured to define a track-width TW of the sensor, but it could also be configured to define a stripe height of the sensor. Then, with reference to FIG. 7, an ion milling operation is performed to remove portions of the CMP stop layer 505 and sensor layer 504 that are not protected by the mask 504 so as to transfer the image of the mask 506 onto these under-lying layers 505, 504.

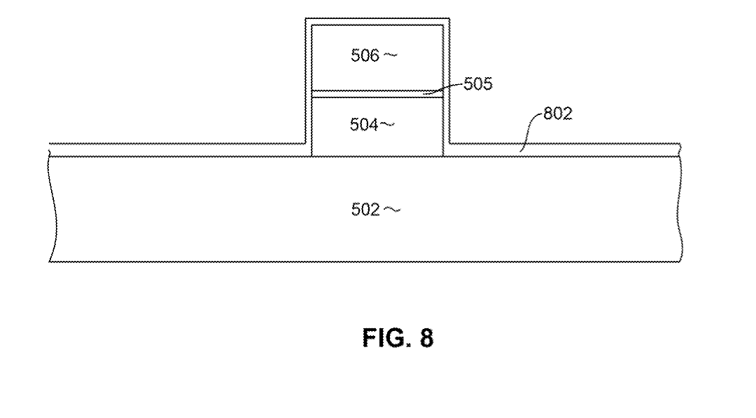

With reference now to FIG. 8, a first layer of insulation 802 is deposited by either ion beam deposition or physical vapor deposition. This layer 802 corresponds to the first insulation layer 330 discussed above with reference to FIGS. 3 and 4. As discussed above, this layer 802 can be deposited very thin, and in as non-conformal manner (such as being thinner at the sides of the sensor layer 504 and thicker across the horizontal shield 504 and can be deposited without concern for pin holes or defects. The layer 802 can be oxygen deficient alumina (Al₂O₃₋ₓ). SiNx, SiOxNy, MgO, or combination thereof. Alumina provides better breakdown voltage, but SiNx, SiOxNy and MgO are better O₂ diffusion barriers.

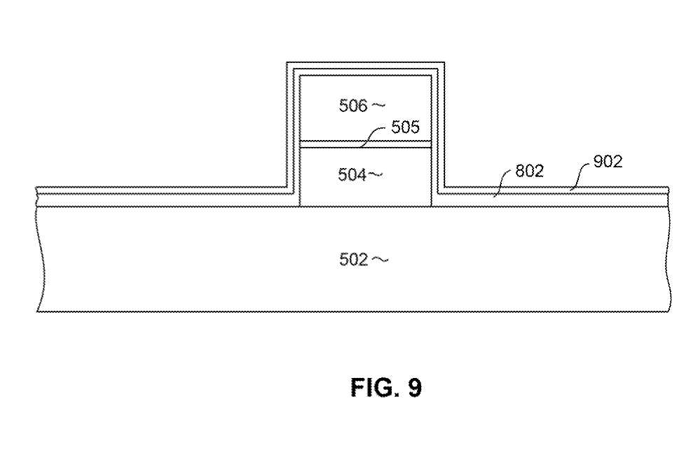

Then, with reference to FIG. 9, a second layer of insulation material 902 is deposited by atomic layer deposition (ALD). The second insulation layer 902 corresponds to the second insulation layer 332 described above with reference to FIGS. 3 and 4. This layer 902 is preferably alumina (Al₂O₃) and acts to seal any pin holes or defects in the first insulation layer 802.

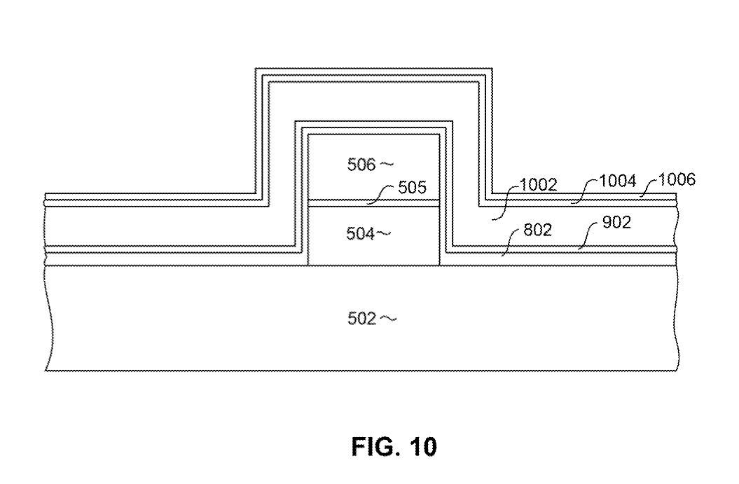

Then, with reference to FIG. 10, a layer of hard magnetic bias material such as CoPt or CoPtCr 1002 is deposited over the second insulation layer 902, and a hard bias capping layer 1004 is optionally deposited over the hard bias layer 1902. The hard bias layer 1002 may also include one or more seed layers, however these are not shown here for purposes of clarity. A CMP stop layer 1006 such as carbon or diamond like carbon can be deposited over the hard bias capping layer 1004.

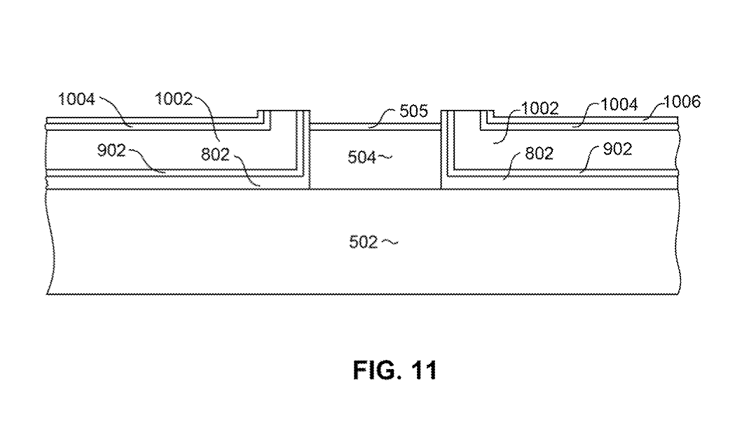

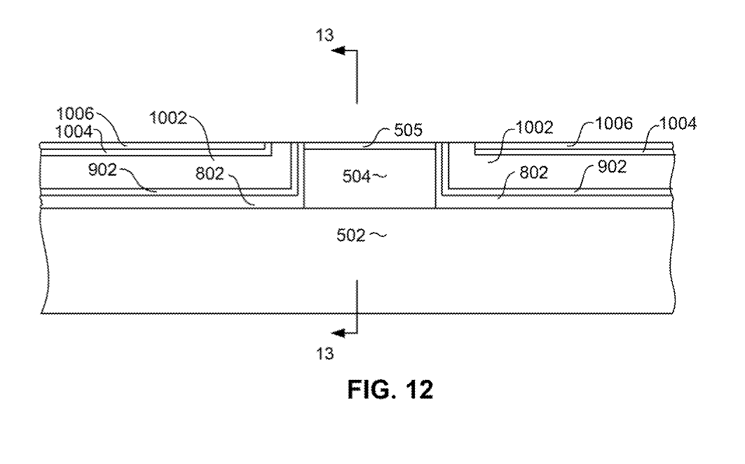

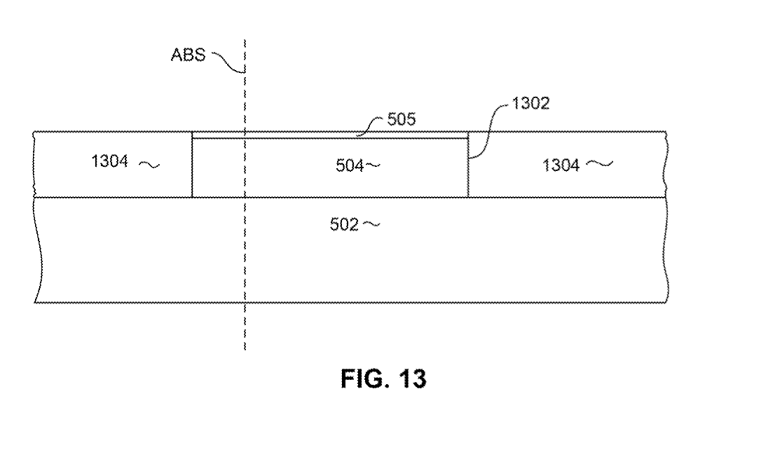

A liftoff process can then be performed to remove the mask structure 506, leaving a structure as shown in FIG. 11. A light chemical mechanical polishing can then be performed to planarize the structure leaving a structure as shown in FIG. 12. FIG. 13 is a cross sectional view as seen from line 13-13 of FIG. 12. As seen in FIG. 13, another masking and ion milling process can be performed to define a back edge 1302 of the sensor to define a stripe height of the sensor as measured from the air bearing surface plane ABS to the back edge 1302 of the sensor. Then, non-magnetic, electrically insulating fill material such as alumina (Al₂O₃) can be deposited and another chemical mechanical polishing can be performed, leaving the structure as seen in FIG. 13.

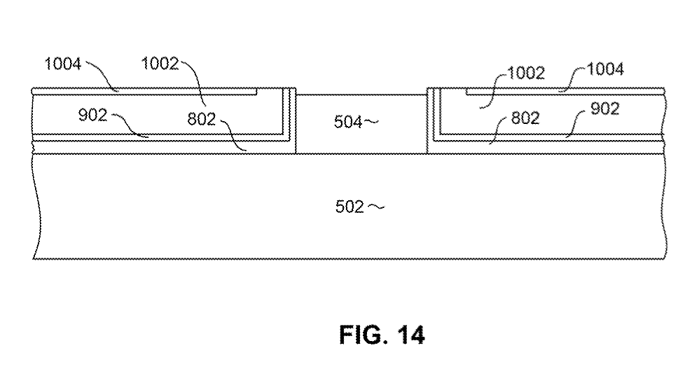

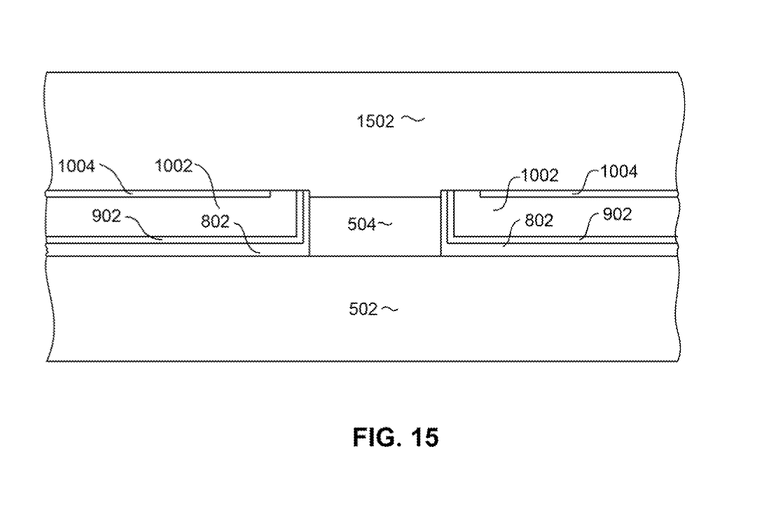

With reference to FIG. 14, which shows a view parallel with the ABS similar to FIG. 12, a reactive ion etching can be performed to remove the CMP stop layer 505 and to expose the sensor layer 504. Then, with reference to FIG. 15, a magnetic, upper shield 1502 can be formed, such as by electroplating. It should also be pointed out that while the above process has been described as defining the track width first and then the stripe height, the order of these operations could also be reversed. The masking and ion milling to define the stripe height (as in FIG. 13) could be performed first, followed by the definition of the track width and deposition of the insulation layer structure 802, 902 and hard bias 1002 as described with reference to FIGS. 5-12.

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A method for manufacturing a magnetic read sensor, comprising:
forming a sensor structure having first and second sides over a magnetic shield;
depositing a first insulation layer over the sensor structure by ion beam deposition or physical vapor deposition; and
depositing a second insulation layer by atomic layer deposition over the first insulation layer.

2. The method as in claim 1, wherein the first insulation layer comprises one or more of oxygen deficient Al₂O₃₋ₓ, SiNx, SiOxNy and MgO, and the second insulation layer comprises Al₂O₃.

3. The method as in claim 1, wherein the both the first insulation layer and the second insulation layer comprise Al₂O₃.

4. The method as in claim 1, wherein the first insulation layer contains pin holes, and the second insulation layer seals the pin holes of the first insulation layer.

5. The method as in claim 1, wherein the first insulation layer is non-conformal and the second insulation layer is conformal.

6. The method as in claim 2, wherein the first insulation layer has a greater thickness at the sides of the sensor structure than over the magnetic shield and the second insulation layer has a uniform thickness over the sides of the sensor structure and over the magnetic shield.

7. The method as in claim 1, further comprising, after depositing the second insulation layer, depositing a layer of hard bias material over the second insulation layer.

8. The method as in claim 1, further comprising, after depositing the second insulation layer, depositing a layer of hard bias material and then performing a chemical mechanical polishing.

9. The method as in claim 1, further comprising, after depositing the second insulation layer, depositing a layer of hard bias material, depositing a hard bias capping layer and performing a chemical mechanical polishing.

10. The method as in claim 1, wherein the forming of the sensor structure further comprises:
depositing a sensor layer;
forming a mask over the sensor layer;
performing an ion milling to remove portions of the sensor material that are not protected by the mask structure, and wherein
the first and second insulation layers are deposited over the mask as well as over the sensor structure and magnetic shield.

11. The method as in claim 12, further comprising, after depositing the second insulation layer:
depositing a layer of hard bias material;
depositing a hard bias capping layer;
performing a liftoff process to remove the mask; and
performing a chemical mechanical polishing.

12. A magnetic read sensor, comprising:
a magnetic shield;
a sensor stack haying a side formed on the magnetic shield; and
a bi-layer insulation layer formed over the side of the sensor stack and over the magnetic shield, the bi-layer insulation layer having a first insulation layer and a second insulation layer formed over the first insulation layer.

13. The magnetic read sensor as in claim 12, wherein the first insulation layer comprises one or more of oxygen deficient Al₂O₃₋ₓ, SiNx, SiOxNy and MgO, and the second insulation layer comprises Al₂O₃.

14. The magnetic read sensor as in claim 12, wherein the first and second insulation layers each comprise Al₂O₃.

15. The magnetic read sensor as in claim 12, wherein the first insulation layer comprises a material deposited by ion beam deposition and the second insulation layer comprises a material deposited by atomic layer deposition.

16. The magnetic read sensor as in claim 12, wherein the first insulation layer has pin holes and the second insulation layer fills the pin holes in the first insulation layer.

17. The magnetic read sensor as in claim 12, wherein the first insulation is non-conformal and the second insulation layer is conformal.

18. The magnetic read sensor as in claim 12, wherein the first insulation layer has a thickness over the magnetic shield that is greater than its thickness over the side of the sensor stack.

19. The magnetic read sensor as in claim 12, wherein the first insulation layer has a thickness over the magnetic shield that is greater than its thickness over the side of the sensor stack, and the second insulation layer has a uniform thickness over both the magnetic shield and the side of the sensor stack.
